(19) United States
(12) Patent Application Publication
(10) Pub. No.: US 2009/0179117 A1
(43) Pub. Date: Jul. 16, 2009

(54) Breathing apparatus hose support

(76) Inventor: Christopher Thomas, Little Rock, AR (US)

Correspondence Address: SPEED LAW FIRM, 111 CENTER STREET, SUITE 1200, LITTLE ROCK, AR, 72201, US

(21) Appl. No.: 12/319,989

(22) Filed: Jan. 14, 2009

Related U.S. Application Data
(60) Provisional application No. 61/011,173, filed on Jan. 14, 2008.
(60) Provisional application No. 61/124,373, filed on Apr. 16, 2008.

(51) Int. Cl. F16L 3/08

(52) U.S. Cl. 248/70; 248/65

(57) ABSTRACT

Embodiments include a method and apparatus for supporting a hose or conduit of a breathing apparatus such as a CPAP or BIPAP apparatus. A conduit support apparatus of embodiments may include a gravity-driven pulley support system. Embodiments further include a method of operating the conduit support apparatus.

### CROSS-REFERENCE TO RELATED APPLICATIONS

This application claims benefit of U.S. provisional patent application Ser. No. 61/011,173, filed Jan. 14, 2008, which is herein incorporated by reference. This application also claims benefit of U.S. provisional patent application Ser. No. 61/124,373, filed Apr. 16, 2008, which is herein incorporated by reference.

### BACKGROUND OF THE INVENTION

1. Field of the Invention

Embodiments generally relate to supporting a conduit such as a hose of a breathing apparatus.

2. Description of the Related Art

Sleep apnea (e.g., obstructive sleep apnea) is a widespread and growing problem which results when a person's airway is obstructed while he or she is sleeping. With sleep apnea, the obstruction of the airway while sleeping may prevent proper oxygenation to the person, may lead to heart problems, may increase snoring, and may interrupt sleeping. A breathing apparatus such as a continuous positive air pressure (“CPAP”) apparatus or bi-level positive air pressure (“BIPAP”) apparatus (such as the Respironics M Series Plus C-Flex CPAP machine or Respironics M-Series Pro C-Flex CPAP machine) is often utilized to alleviate the symptoms of sleep apnea by forcing air into a person's airway through a mask connected to a CPAP or BIPAP machine via a hose through which air may flow into the mask. The mask is placed on the person's face over the person's airway so that air flows from the CPAP or BIPAP machine, through the hose, and into the person's airway to provide air/oxygen to the person. A swivel mechanism (such as a Respironics M Series Tubing Swivel) may optionally be attached at one end to the CPAP or BIPAP machine and at its other end to an end of the hose to permit swiveling of the hose relative to the machine. An example CPAP machine is a Respironics M Series machine, and an example swivel mechanism is a Respironics M Series swivel.

Common problems with current CPAP and BIPAP machines relate to the hose. A person typically rolls over or moves during sleep into different positions. Rolling over or moving during sleep often crimps the hose, restricting or closing off air/oxygen flow through the hose. At the very least, the hose is typically in the way while a person is sleeping or attempting to fall asleep because the hose is inadequately supported. The hose may also become hung on bedding. These problems constitute an annoyance and cause non-use of the breathing machine to avoid these problems, which may lead to restricted breathing, inadequate oxygenation, heart problems, and even early death due to non-use of the doctor-prescribed equipment.

Therefore, there is a need for a device which adequately supports the hose or conduit of a breathing apparatus, even upon change in position of the hose. There is further a need for a device which adequately supports the hose without inhibiting, obstructing, or closing off air and/or oxygen flow through the hose, especially when the hose changes position. There is yet a further need for a method for providing adequate support to a hose or conduit of a breathing apparatus, even upon change of position of the hose or conduit.

### SUMMARY OF THE INVENTION

Embodiments generally include a conduit support apparatus for supporting a conduit of a breathing apparatus, comprising a first conduit supporting member; and a second conduit supporting member, wherein the conduit is moveable relative to the first and second conduit supporting member, and wherein the conduit support apparatus is a gravity-driven pulley support system. Further embodiments include a method of supporting a moveable conduit of a breathing machine, comprising providing a gravity-driven pulley support system for supporting the conduit and allowing movement of the conduit therethrough; placing the conduit in the pulley support system; and supporting movement of the conduit using the pulley support system.

### BRIEF DESCRIPTION OF THE DRAWINGS

So that the manner in which the above-recited features of embodiments can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a front perspective view of a first embodiment of a hose support apparatus.

FIG. 1A is a cross-sectional view through a portion of the hose support apparatus.

FIG. 2 is a front section view of the hose support apparatus of FIG. 1 showing arm detail.

FIG. 3 is a downward plan view of the hose support apparatus of FIG. 1.

FIG. 4 is a side view of the hose support apparatus of FIG. 1.

FIG. 5 is a front perspective view of the hose support apparatus of FIG. 1, also showing a breathing apparatus, swivel mechanism, and hose therewith.

FIG. 6 is a front perspective view of the hose support apparatus of FIG. 1, also showing a breathing apparatus, hose, swivel mechanism, table, and bed therewith.

FIG. 7 is a section view of a hose support capable of use with the hose support apparatus of FIGS. 1-6.

FIG. 8 is a downward plan view of a second embodiment of a hose support apparatus.

FIG. 9 is a side view of the hose support apparatus of FIG. 8.

FIG. 10 is a section view of a hose support capable of use with the hose support apparatus of embodiments.

FIG. 11 is a front perspective view of the hose support apparatus of FIG. 8.

FIG. 12 is a front perspective view of a hose support apparatus showing one or more vertically adjustable hose support members.

FIG. 13 is a downward plan view of a hose support apparatus showing one or more orbitally adjustable hose support members.

FIG. 14 is a front perspective view of a hose support apparatus showing one or more rotatably adjustable hose support members.

FIG. 15 shows a further alternate embodiment of a hose support apparatus.

### DETAILED DESCRIPTION

Embodiments include a hose support apparatus which is usable with a breathing apparatus such as a continuous positive air pressure (“CPAP”) or bi-level positive air pressure (“BIPAP”) apparatus. Any breathing apparatus with a conduit or a hose for is capable of being used with the hose support apparatus, as well as any apparatus requiring support for a hose or conduit through which gas or fluid is flowable. The hose support apparatus is capable of supporting a hose or other conduit through which a gas such as air and/or oxygen may flow. The hose support apparatus is generally a gravity-driven pulley support system and device which allows patient movement while keeping the hose free from obstruction. In one embodiment, the gravity-driven pulley support system and device includes two opposing and angled support arms.

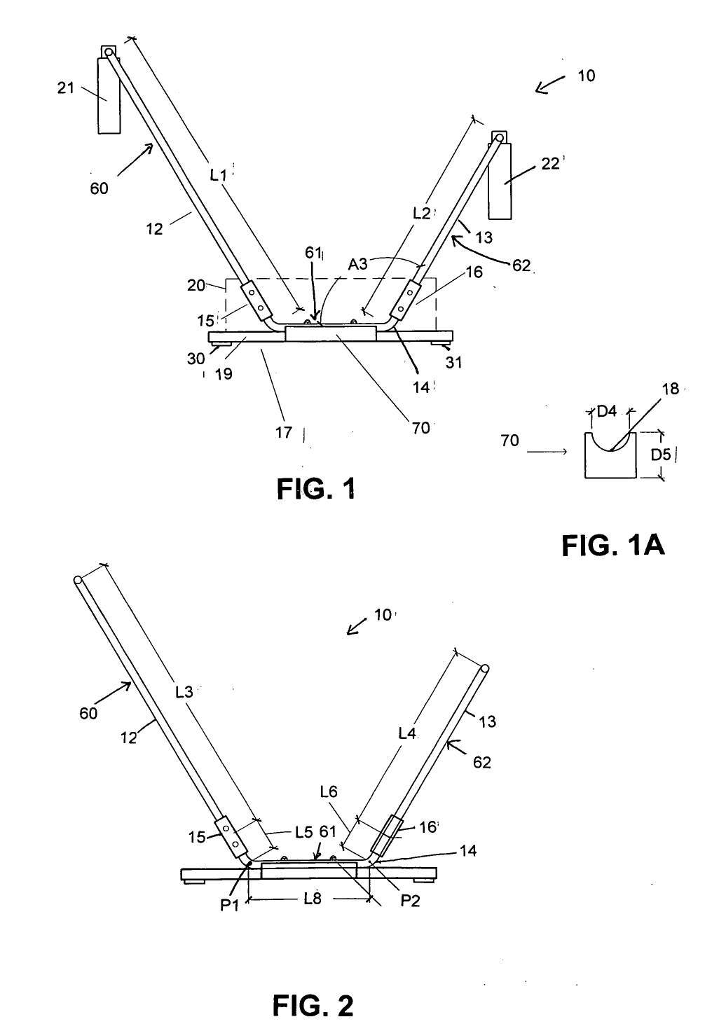

The gravity-driven pulley support system and device described and shown herein supports a hose or other conduit operatively connected to a breathing machine to alleviate and/or eliminate the problems relating to the hose described in paragraph [0004]. In one embodiment, as shown in FIGS. 1-7, the gravity-driven pulley support system and device includes a conduit support apparatus 10.

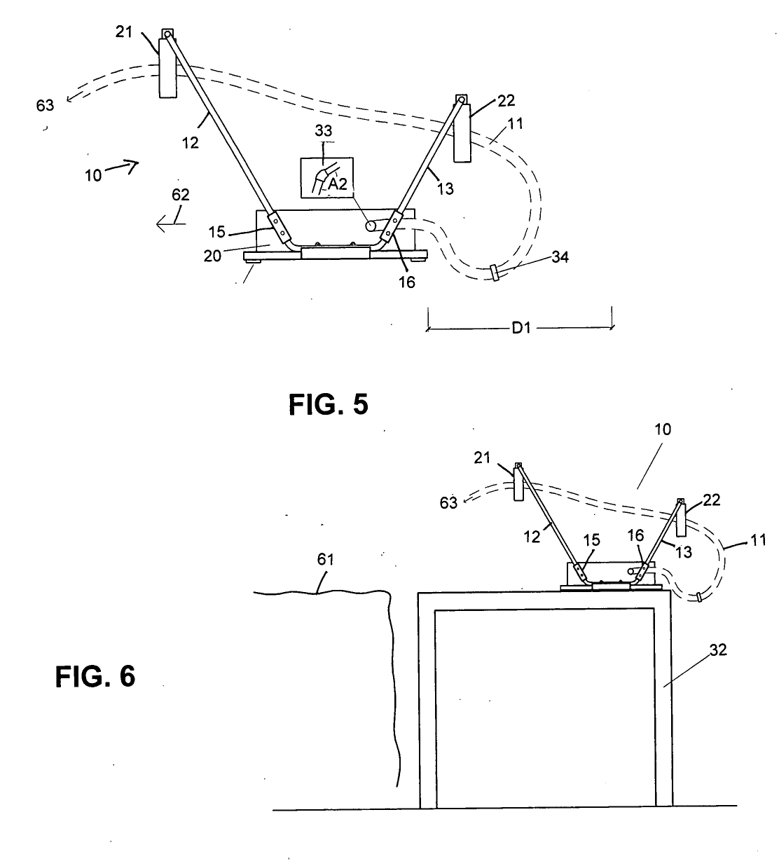

The conduit support apparatus 10 includes a pulley support system which may include one or more arms for moveably supporting a conduit such as a hose 11 (see FIGS. 5-7). In the shown embodiments, the pulley support system includes a first arm 12 and a second arm 13. The first and second arms 12 and 13 may be removably connected to one another via an arm connector 14. A first end of the arm connector 14 may be operatively connected to a second end of the first arm 12 via a first connecting mechanism 15, while a second end of the arm connector 14 may be operatively connected to a second end of the second arm 13 via a second connecting mechanism 16. The first and second arms may include, for example, metal rods. In one preferred embodiment, the metal rods are aluminum rods and may be ⅜-inch aluminum rods. The first and second connecting mechanisms 15, 16 may include, for example, one or more splicers or reducers. A preferred splicer/reducer is an aluminum electrical connector manufactured by Thomas & Betts model ASR1114-B2 at 2 inches long.

A first pivot point P1 exists where a first support member 60 meets a second support member 61, and a second pivot point P2 exists where the second support member 61 meets a third support member 62. In the exemplary embodiment shown in the figures herein, the pivot points P1 and P2 exist in the bends on the arm connector 14; however, any combination of members may instead make up the supports and pivot points, including but not limited to providing connections at the pivot points. In one exemplary embodiment shown in FIGS. 1 and 2, the length L1 of the first support member 60 is approximately 20 inches, the length L8 of the second support member 61 is approximately 6 inches, and the length L2 of the third support member 62 is approximately 13 inches. In this embodiment, the length L3 from an end of the first arm 12 to a center of the first connecting mechanism 15 is approximately 18 inches, the length L5 from the center of the first connecting mechanism 15 to the pivot point P1 is approximately 2 inches, the length L4 from an end of the second arm 13 to a center of the second connecting mechanism 16 is approximately 13 inches, and the length L6 from the center of the second connecting mechanism 16 to the pivot point P2 is approximately 2 inches. In an exemplary embodiment, an angle A3 between the third support member 62 and the second support member 61 is approximately 115 degrees, and the angle between the first support member 60 and the second support member 61 is approximately the same. This embodiment is only exemplary, and other and further embodiments may include different dimensions of the components.

A base 17 may be operatively connected to the pulley support system, for example at or near the arm connector 14 with one or more connecting mechanisms such as one or more fasteners which may include one or more screws. Although the base 17 may be connected to the arms 12, 13 by any connection method or means known to those skilled in the art, in the shown example embodiment, the base 17 is connected to the arm connector 14 by an aperture 18 in the base 17 formed to receive the arm connector 14. For example, when the arm connector 14 is a rod, the aperture 18 may be formed in an attaching member 70, which may be a square or rectangular rod, which is operatively attached to the base 17, as shown in FIG. 1A, to receive the outer diameter of the arm connector 14. In one embodiment, the attaching member 70 is an approximately 6-inch length ⅝-inch square routed to receive the arm connector 14, the aperture width D4 is approximately ⅜ inches and the height D5 of the attaching member 70 is approximately ⅝ inches. Other configurations of the attaching member 70 or elimination of the attaching member 70 are possible alternate embodiments, and the dimensions of the components are merely exemplary and not limiting of embodiments.

In an embodiment, the arm connector 14 is disposed in the aperture 18, and machine screws with cap nuts and lock washers are located in corresponding holes through the arm connector 14 and through the base 17. The screws may be, for example, #10-32×1¼ inch length machine screws with round heads and cap nuts and lock washers.

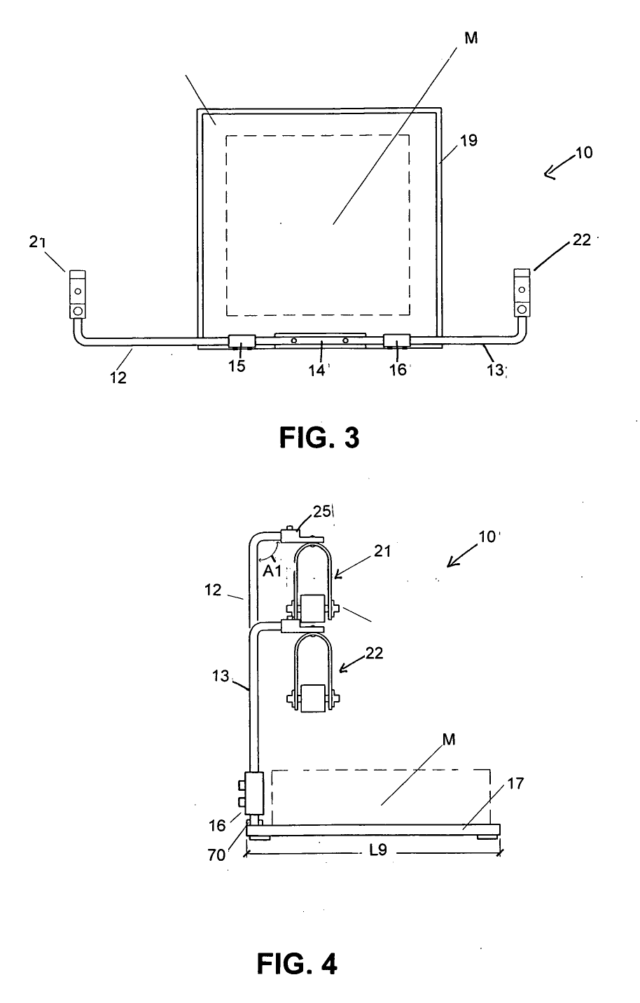

The base 17 may receive a breathing apparatus 20 such as a CPAP or BIPAP machine thereon at a machine location M, for example, (denoted by the dotted lines in FIGS. 3 and 4) and may be sized and configured to receive the breathing apparatus 20 thereon, as shown by the dotted lines in FIGS. 1 and 3-4 and as shown also in FIGS. 5-6. In one embodiment which is not limiting of embodiments of the invention, the base 17 may include approximately 12-inch by approximately 12-inch high density polyethylene material or 0.223 acrylic base material. Other and further base 17 embodiments may include other dimensions and types of materials.

Optionally, the base 17 may include a containment rim 19 therearound to contain water or other fluid exiting from the breathing apparatus 20 during its use. Although any dimensions of the containment rim 19 may be included in embodiments, in one embodiment the container rim 19 is raised approximately 0.5 inches from an upper surface of the base 17. The containment rim 19 may in one embodiment include one or more 0.5-inch square rim containment pieces. Additionally, any other containing member may be utilized with the hose support apparatus 10 to contain fluid at a location on the breathing apparatus 20. In one example embodiment, the base 17 is approximately 1 foot in length L9, which is not intended to be limiting but rather an example of dimensions of the base 17.

As shown in FIG. 4, the arms 12 and 13 may be located at a back end of the base 17, and the first ends (e.g., the upper ends) of the arms 12 and 13 may curve inward over the base at an angle A1, which may be an approximately 90 degree angle. Any angle A1 or no angle is contemplated by the inventor to be included in embodiments.

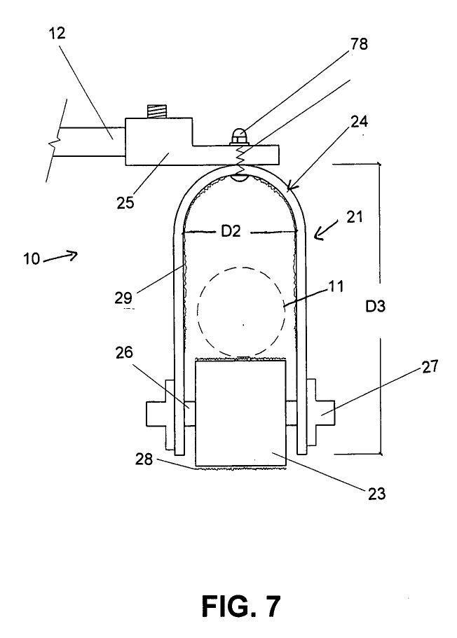

Operatively connected to each arm 12, 13 (in one embodiment, operatively connected at or near a first end of each arm 12, 13) is a hose support. Operatively connected to the first arm 12 (e.g., at or near the first end of the first arm 12) is a first hose support 21, while operatively connected to the second arm 13 (e.g., at or near the first end of the second arm 13) is a second hose support 22. As shown in FIG. 7, each hose support 21, 22 may include a rolling mechanism such as a roller or wheel 23 rotatably connected to a roller support or wheel support 24, which may be U-shaped as shown in FIG. 7 (of course, the support 24 may take any shape capable of providing support to the rolling mechanism 23). If the wheel support 24 is U-shaped, it may be oriented as an upside-down “U” with the wheel 23 operatively attached to the lower portion of the upside-down “U.” Each wheel support 24 may be made of any material capable of supporting the wheel 23 and hose 11, but in one embodiment, each may include an approximately ⅛-inch thick, approximately ¾-inch wide, metal (e.g., aluminum) strip. In an embodiment, the hose support inner surfaces are disposed a distance D2 of approximately 1.75 inches from one another, and the distance D3 from the uppermost surface of the wheel support 24 to the lowermost surface of the wheel support 24 is approximately 3¾ inches (but any other distances are capable of use with embodiments which allows clearance of the hose 11 therethrough and supports the hose dispenser (e.g., the wheel 23).

One or more spacers 26 may be utilized to operatively connect the wheel 23 to the surrounding wheel support 24. In one embodiment, the spacers 26 may be 5/16-inch plastic tubing spacers, but any dimensions and types of materials are contemplated for use as spacers or for performing the function of the spacers. A rod with axle nuts 27 on its ends may be operatively connected to the outer diameter of the wheel support 24. The rod with axle nuts may be replaced by any other mechanism for maintaining a generally stationary support relative to the moveable wheel 23. In an embodiment, the rod with axle nuts 27 is approximately 5/16-inch in diameter and approximately 2.5-inches in length and is a metal (e.g., steel or aluminum) rod with axle nuts on its ends.

Each hose support 21, 22 may be operatively connected to its respective arm 12 or 13 via one or more connectors 25 such as an aluminum electrical connector by Thomas & Betts Model ADR11-B1, for example by connecting each connector 25 to the lower end or bottom of the upside-down “U” via one or more connecting mechanisms such as one or more screws with cap nuts and washers. Example screw, cap nut, and washer configurations are shown in FIGS. 1-7. In one embodiment, a #10-32 cap nut with lock washer and a #10-32×½-inch roundhead machine screw is utilized to connect the connector 25 to the hose support 21, 22. Each hose support 21, 22 may include, for example, one or more skate wheels, such as the Heelys skate wheel model #5021 medium. One or more felt strips 28 may be attached to the wheels 23, for example, via adhesive backing, to ease rolling of the hose 11 over the wheels 23. Additionally, one or more felt strips 29 may be attached to an inner surface of the wheel supports 24 to ease the flow of the hose 11 through the wheel supports 24. In the alternate, any type of material and any configuration of the material may be included with the wheels 23 and wheel support 24 to ease the rolling of the hose 11 over the wheels 23 and through the wheel support 24.

One or more felt pads 30, 31 may be attached to the lower end or bottom of the base 17 to prevent scratching of a surface 32 on which the base 17 rests. The surface 32 may be, for example, a bedside table or stand. An example surface 32 is a 25-inch to 30-inch bedside table. Of course, any other dimensions and types of surfaces 32 may be utilized with embodiments disclosed herein. Any other types of material known to those skilled in the art may optionally be placed on the lower end of the base 17, in addition to or in lieu of the felt material, to prevent scratching on the surface 32.

A swivel mechanism 32 (see FIG. 5) such as a 360-degree Respironics M-Series hose swivel may optionally operatively attach the hose 11 to the breathing apparatus 20 to ease manipulation of the hose 11 through the hose supports 21, 22 over the wheels 23 in operation. In one embodiment, the angle A2 of the swivel is approximately 75 degrees. The hose support apparatus 10 may be used with or without the swivel mechanism 32. When the swivel mechanism 32 is not employed, the hose 11 is operatively attached to the breathing apparatus 20, for example at or near the opposite end of the hose 11 from the mask.

The hose support apparatus 10 is a pulley support system which is counterweighted in order to take advantage of the force of gravity to operate the system. One or more counterweights 34 may be located on the hose 11 and for example may include one or more lengths of malleable material such as malleable metal (e.g., lead) which may be covered by Velcro® and/or fabric. The one or more counterweights 34 are preferably moveable along the length of the hose 11 to vary the counterweight and thus vary the pull on the other end of the hose 11 (the end with the mask connected thereto) and may be operatively attachable to the hose 11 via one or more pieces of Velcro® material, for example using one or more self-adhesive Velcro® strips. Any other attachment method or member known to those skilled in the art may be utilized to operatively attach the counterweight(s) 34 to the hose 11. In one exemplary embodiment, the counterweight is approximately 1 ounce to approximately 2 ounces. Of course any other dimensions and configurations of the counterweight may be utilized. The counterweight may take any configuration which provides a counterweight for the hose, including any type of counterweight known to those skilled in the art.

The CPAP or BIPAP hose 11 may include any hose for a breathing machine, but in one exemplary embodiment is a 6-foot hose. As shown in FIG. 5, the distance D1 from an end of the base 17 to the wall should be at least 12 inches to permit adequate hose movement. FIG. 6 shows a bed 61 beside the bedside table 32 with the apparatus 10 thereon, and an arrow 62 in FIG. 5 shows an exemplary direction of the bed location relative to the apparatus 10.

In operation, a mask (not shown) is operatively connected to one end of the hose 11 (the arrows 63 in FIGS. 5 and 6 denote the direction of the flow of air in the hose on which the mask is connected), and the hose 11 is operatively connected at its other end to the breathing apparatus 20, for example via the swivel mechanism 33. The hose 11 is disposed through the opening through the hose supports 21, 22 above the wheels 23 and rests on the wheels 23. In this way, the hose 11 is supported therearound by the hose supports 21, 22 on the wheels 23. The mask is then placed over the person's airway. The breathing apparatus 20 may be plugged in and turned on at any time. When the person moves into different positions, the hose 11 easily moves through the hose supports 21, 22. The pulley support system, via gravity, helps control the tautness of the hose 11 rolling over the wheels 23, without the hose crimping, getting in the way of the person, or “collapsing” between the hose supports 21, 22.

The support apparatus 10 may be easily disassembled in some embodiments, where one or more of the following components are readily removable from one another: the connecting rod 14 may be removable from the aperture 18 of the base 17, the arms 12, 13 may be removable from the connectors 15, 16 and from the connecting rod 14, the connecting rod 14 may be removable from the connectors 15, 16 and from the arms 12, 13, and the hose supports 21, 22 may be removable from the arms 12, 13. Easy disassembling of one or more of these components from one another allows for an easily transportable kit or caddy for a breathing machine, hose, and hose support apparatus.

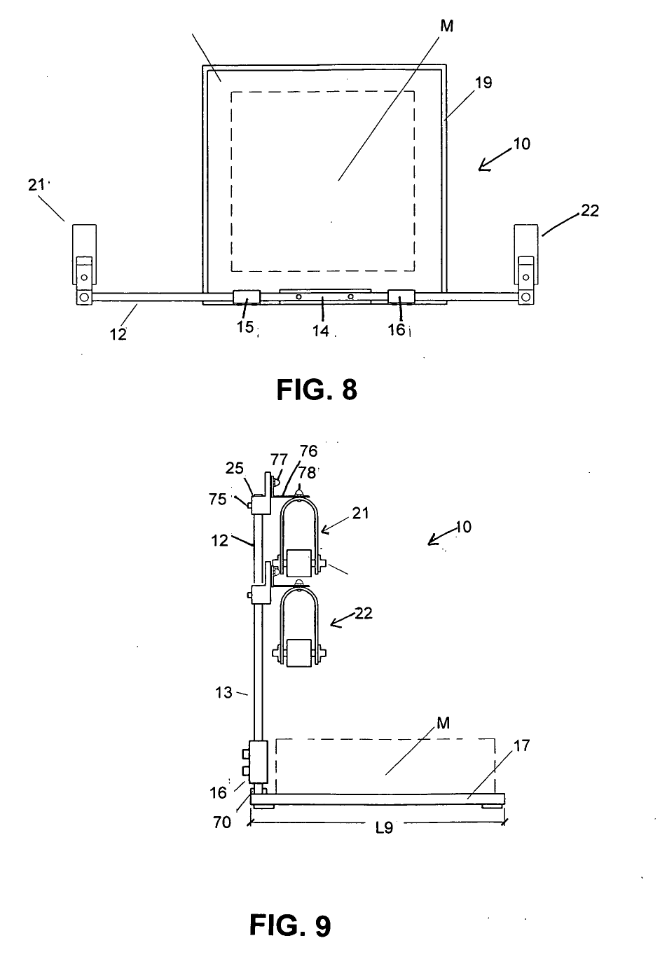

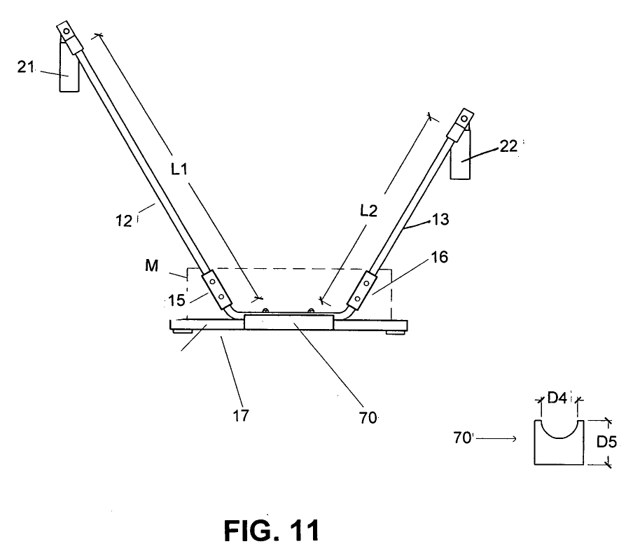

FIGS. 8-15 show variations on the embodiments of the hose support apparatus 10 depicted and described above with respect to FIGS. 1-7. In these figures, like components to those in FIGS. 1-7 are denoted with like numbers in FIGS. 8-15.

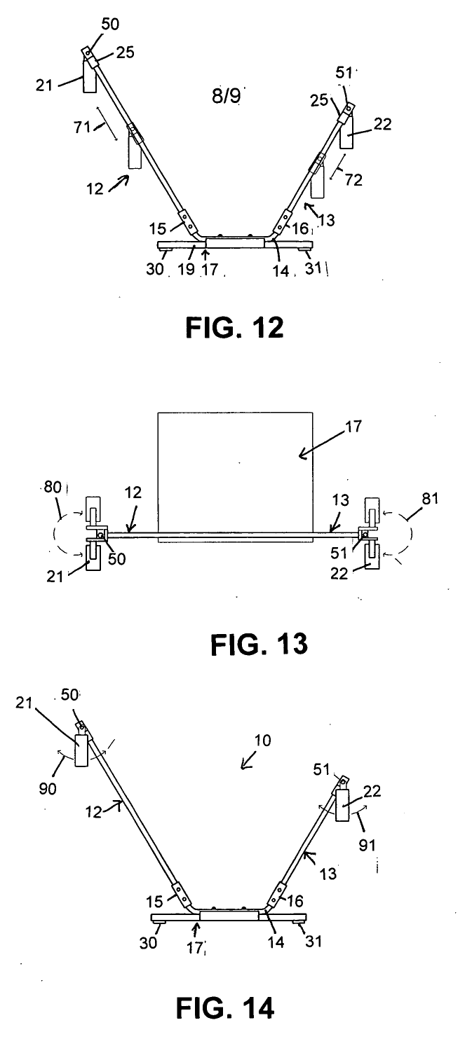

In the embodiment of these figures, the hose supports 21 and 22 may be adjustable and lockable in place along the length of their respective arms 12 and 13 as well as adjustable and lockable in place orbitally and/or rotationally in relation to their respective arms 12 and 13. The adjustable functionality allows the user to raise or lower either or both of the hose supports 21 and/or 22 to accommodate his or her particular situation, taking into consideration one or more of the following factors: the height of the user's bedside table; how close or far away from a wall the patient desires the hose to be located; how much space he or she has on the surface of the table; how much “pull” he or she wants on the hose (by raising the bedside support higher and the opposite support lower, creating more of a “drop” and hence increasing the effect of the counterweight). This user friendly hose support apparatus depicted in FIGS. 12-14 allows adjustment according to the user's needs or desires.

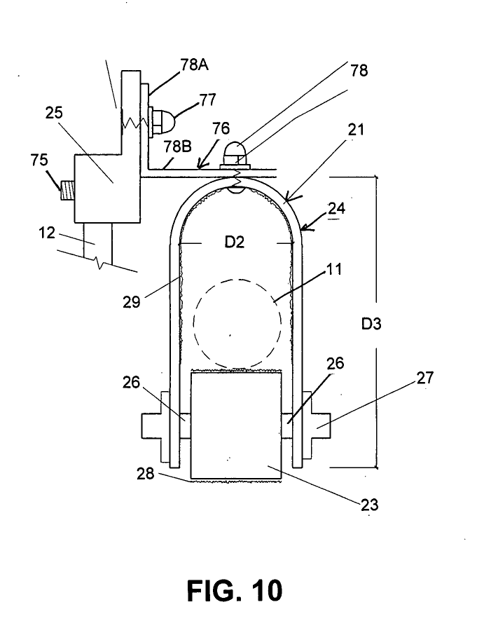

As best shown in FIGS. 9 and 12, one or more of the hose supports 21 and 22 may be adjustable to slide along the length of their respective arms 12 and 13 (the possible movement denoted by the arrows 71 and 72), thereby allowing adjustment of the height of any hose disposed in the hose supports 21 and 22 and/or adjustment of the relative slope of the hose between the two arms 12 and 13. To adjust the position of the hose support 21 along the length of the arm 12, a locking mechanism 75 (as shown in FIG. 7) of the hose support 21 may be disengaged to allow the hose support 21 to move along the length of the arm 12, and the connector 25 is moved along the length of the arm 12 to the desired location (the same position adjustment method is utilized for the hose support 22). When the hose support 21 is disposed at the desired location, the locking mechanism may be engaged to lock the hose support 21 in that desired position. The locking mechanism may include one or more fasteners such as one or more screws or any other locking mechanism(s) for releasably locking two mechanical pieces slidable with respect to one another which is known to those skilled in the art. As is shown in FIG. 9, the arms 12, 13 may optionally not include a bend at their upper ends with the angle A1 as shown in FIG. 4. In the embodiment depicted in FIG. 9, an additional positioning member 76 may be operatively connected to the connector 25 and the hose support 21 (e.g., via one or more connecting members 77 and 78 such as screws, bolts, and/or nuts 77) to allow the hose support 21 to remain vertically disposed upon its adjustment and movement along the rod 12. The positioning member 76 may include a first leg 78A and a second leg 78B (which may be separate members or one molded piece) disposed approximately perpendicular to one another as shown in FIGS. 9 and 10. The first connecting member 77 may connect the positioning member 76 to the connector 25, while the second connecting member 78 may connect the positioning member 76 to the hose support 21. In one example, the connecting member 77 may include one or more #10-32 flathead machine screws flush with the surface of the connector 25, and the connecting member 78 may include one or more #10-32×½-inch roundhead machine screws with one or more #10-32 cap nuts with lock washers. The hose support 22 may be releasable, moveable, and lockable in position with respect to the arm 13 in the same manner and with a similar locking mechanism as described above in relation to hose support 21 and arm 12.

Also, as shown in FIGS. 13, one or more of the hose supports 21 and 22 may be adjustable orbitally around pivotal point 50 of hose support 21 with respect to arm 12 and/or around pivot point 51 of hose support 22 with respect to arm 13 (arrows 80 and 81 show orbital paths of the hose supports 21 and 22). To orbit the hose support 21 around the pivotal point 50, the user disengages a locking mechanism 75 holding the hose support 21 in orbital place with respect to the arm 12, orbits the hose support 21 around the pivotal point 50, and then engages the locking mechanism 75 to hold the hose support 21 in place at its new location. The locking mechanism may include a fastening mechanism such as a screw (commonly known as a set screw) and optional nut which is capable of unscrewing (loosening) to unlock the locking mechanism and thereby allow orbital movement of the hose support 21 around the pivotal point 50 and screwing (tightening) to lock the locking mechanism into position with respect to the arm 12 and thereby prevent orbital movement of the hose support 21 around the pivotal point, or the locking mechanism may include any other locking mechanism for releasably locking two mechanical pieces orbital with respect to one another which is known to those skilled in the art. The hose support 22 is orbital and lockable around the pivotal point 51 in the same manner and includes a locking mechanism similar to or the same as described above with respect to the hose support 21 and pivotal point 50. The same locking mechanism may be utilized to vary the position of the one or more hose supports 21 and 22 along the length of their respective arms 12 and 13 as shown in FIG. 12, and the same locking mechanism may be utilized to vary the rotational positions of the one or more hose supports with respect to their respective arms 12, 13 as shown in FIG. 14.

Additionally, as depicted in FIG. 14, one or more of the hose supports 21 and 22 may be adjustable rotationally around pivotal point 50 of hose support 21 with respect to arm 12 and/or around pivotal point 51 of hose support 22 with respect to arm 13 (arrows 90 and 91 show rotational paths of the hose supports 21 and 22). To rotate the hose support 21 around the pivotal point 50 (the rotation similar to that of a wheel), the user disengages a locking mechanism 75 holding the hose support 21 in rotational place with respect to the arm 12, rotates the hose support 21 around the pivotal point 50, and then engages the locking mechanism 75 to hold the hose support 21 in place at its new location. The locking mechanism may include a fastening mechanism such as a screw (commonly known as a “set screw”) and optional nut which is capable of unscrewing (loosening) to unlock the locking mechanism and thereby allow rotation of the hose support 21 around the pivotal point 50 and screwing (tightening) to lock the locking mechanism into position with respect to the arm 12 and thereby prevent rotation of the hose support 21 around the pivotal point, or the locking mechanism may include any other locking mechanism for releasably locking two mechanical pieces rotatable with respect to one another which is known to those skilled in the art. The hose support 22 is rotatable and lockable around the pivotal point 51 in the same manner and includes a locking mechanism similar to or the same as described above with respect to the hose support 21 and pivotal point 50. The same locking mechanism may be utilized to vary the position of the one or more hose supports 21 and 22 along the length of their respective arms 12 and 13 as shown in FIG. 12, and the same locking mechanism may be utilized to vary the orbital positions of the one or more hose supports with respect to their respective arms 12, 13 as shown in FIG. 13.

Each hose support 21, 22 of FIGS. 12-14 may be individually and independently adjustable (over the arm length, rotationally, and/or orbitally) relative to its respective arm 12, 13. The adjustable features shown and described in relation to FIGS. 12-14 allow a user to finely tune the tension of the hose 11.

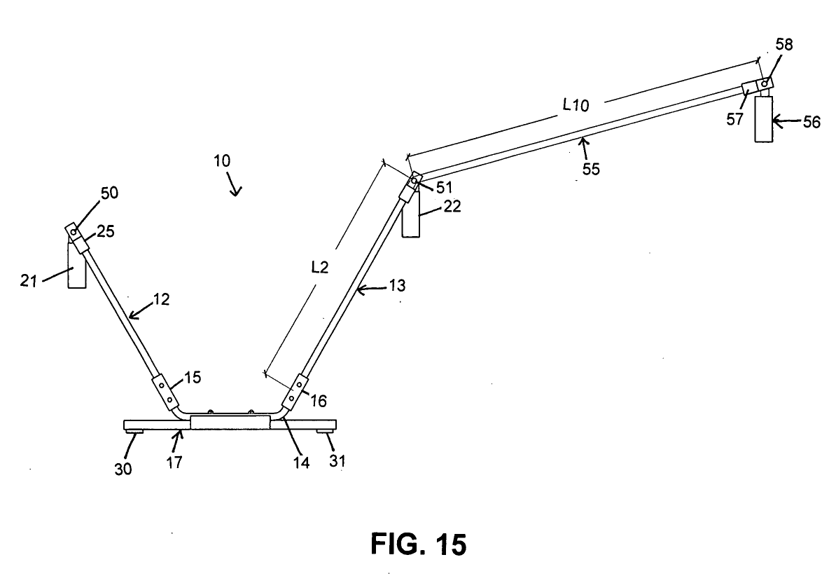

FIG. 15 illustrates yet a further embodiment of the hose support apparatus 10. In the embodiment shown in FIG. 15, an optional attachment to one or more of the arms 12, 13 is an extension arm 55. The extension arm 55 allows the arm to extend over the patient's bed, for example for patients whose masks feed to the CPAP or BIPAP device closer to (e.g., above or directly above) his or her head with respect to the bedside table or other support for the hose support apparatus 10 while he or she is lying in the bed. The extension arm 55 also may include a hose support 56, connector 57, and pivot point 58 similar to or the same as in operation and configuration to the hose support 21, connector 25, and pivot point 50. The connector 57 may be moveable and lockable along the length of the arm 55 as described above in relation to the connector 25, and the hose support 56 may be rotatable with respect to the arm 55 along pivot point 58 as described above in relation to the hose support 21 and pivot point 50. The extension arm 55 may be removable from one or more of the arms 12, 13, may be connectible to the one or more arms 12, 13 via the pivot point 50, 51, and optionally may be pivoted around pivot point 50 or 51 by manipulation of the extension arm 55 around the pivot point 50, 51. The locking mechanism described above may lock the angle of the extension arm 55 with respect to the arm 12 or 13 to which it is connected. The support arm extension 55 may be utilized to deliver the hose directly over a patient's head. In one exemplary embodiment, a length L10 from the pivot point 51 of the hose support 22 to the connector 58 of the hose support is approximately 20 inches. This length is merely an example, and any dimensions of the support arm extension 55 are contemplated as within the scope of the present invention.

FIGS. 1-15 depict and describe merely exemplary configurations and components, including some preferred embodiment sizes and dimensions. Other configurations and components, including sizes and dimensions, known to those skilled in the art and other configurations and components described within this specification are also contemplated as included in embodiments.

While the foregoing is directed to embodiments of the present invention, other and further embodiments of the invention may be devised without departing from the basic scope thereof, and the scope thereof is determined by the claims that follow.

1. A conduit support apparatus for supporting a conduit of a breathing apparatus, comprising:
a first conduit supporting member; and
a second conduit supporting member,
wherein the conduit is moveable relative to the first and second conduit supporting member, and
wherein the conduit support apparatus is a gravity-driven pulley support system.

2. The conduit support apparatus of claim 1, further comprising one or more counterweights disposed on the conduit.

3. The conduit support apparatus of claim 1, wherein the first conduit support member comprises a first arm having a first conduit movement support operatively attached thereto, and wherein the second conduit support member comprises a second arm having a second conduit movement support operatively attached thereto.

4. The conduit support apparatus of claim 3, wherein the first arm is longer than the second arm.

5. The conduit support apparatus of claim 3, wherein the first arm has a height which is larger than a height of the second arm.

6. The conduit support apparatus of claim 3, wherein each of the first and second conduit movement supports comprises a housing having a roller therein, the conduit capable of moving through the housing along the roller.

7. The conduit support apparatus of claim 3, wherein the first arm and second arm are disposed at opposing angles from one another.

8. The conduit support apparatus of claim 3, wherein the first conduit movement support is connected to the first arm at its uppermost end and wherein the second conduit movement support is connected to the second arm at its uppermost end.

9. The conduit support apparatus of claim 3, wherein the first conduit support member is moveable along a length of the first arm.

10. The conduit support apparatus of claim 9, wherein the first conduit support member is moveable generally vertically along the length of the first arm.

11. The conduit support apparatus of claim 3, wherein the first conduit support member is rotatable relative to the first arm.

12. The conduit support apparatus of claim 3, wherein the first conduit support member is orbitally moveable relative to the first arm.

13. The conduit support apparatus of claim 3, further comprising an arm extension member having a third conduit support member operatively attached thereto for supporting a moveable conduit.

14. A method of supporting a moveable conduit of a breathing machine, comprising:
providing a gravity-driven pulley support system for supporting the conduit and allowing movement of the conduit therethrough;
placing the conduit in the pulley support system; and
supporting movement of the conduit using the pulley support system.

15. The method of claim 14, wherein the pulley support system comprises a first arm and a second arm, each arm having a conduit guide operatively connected thereto, the conduit guides permitting movement of the conduit therethrough.

16. The method of claim 14, further comprising counterweighting the conduit.

17. The method of claim 14, further comprising:
placing a breathing apparatus mask on a person; and
using the conduit to provide one or more gases to the person through the mask.

18. The method of claim 15, further comprising:
operatively attaching to the first arm an extension arm having a third conduit guide operatively connected thereto; and
placing the conduit through the third conduit guide.

19. The method of claim 15, further comprising:
moving the conduit guide along a length of the first arm.

20. The method of claim 19, further comprising:
adjusting a rotational position of the conduit guide relative to the first arm.
